(19) United States
(12) Patent Application Publication
(10) Pub. No.: US 2026/0291560 A1
(43) Pub. Date: Sep. 24, 2026

(54) SIGNAL PROCESSING FOR MULTIPLE-INPUT-MULTIPLE-OUTPUT (MIMO) COMMUNICATION

(71) Applicant: Telefonaktiebolaget LM Ericsson (publ), Stockholm (SE)

(72) Inventors: Rui HE, Beijing (CN); Zhao WANG, Taby (SE)

(21) Appl. No.: 19/475,969

(22) PCT Filed: Apr. 19, 2023
(86) PCT No.: PCT/CN2023/089303

§ 371 Date: Oct. 16, 2025

(51) Int. Cl. H04B 7/0456

(52) U.S. Cl. CPC H04B 7/0456

(57) ABSTRACT

Embodiments of the present disclosure are related to signal processing for multiple-input-multiple-output (MIMO) communication. In some embodiments, a radio unit obtains a reference signal received at a first number of antenna elements from a terminal device, signal samples of the received reference signal being organized into the first number of sample sets along a spatial dimension. The radio unit compresses the received reference signal along the spatial dimension, to obtain a compressed reference signal, signal samples of the compressed reference signal being organized into a second number of sample sets along the spatial dimension, the second number being less than the first number. The radio unit transmits the compressed reference signal to a baseband unit via a fronthaul interface. The baseband unit determines a channel estimate by reconstructing on the compressed reference signal, the channel estimate indicating the first number of receiving branches at the network device.

### TECHNICAL FIELD

The non-limiting and embodiments of the present disclosure generally relate to the technical field of telecommunications, and specifically to signal processing for multiple-input-multiple-output (MIMO) communication.

### BACKGROUND

This section introduces aspects that may facilitate a better understanding of the disclosure. Accordingly, the statements of this section are to be read in this light and are not to be understood as admissions about what is in the prior art or what is not in the prior art.

Multiple-input-multiple-output (MIMO) communication is a technique for serving several users simultaneously with the same time and frequency resource in a wireless communication network. This technique, in which the network devices and/or the terminal devices are equipped with multiple antennas, allows for spatial diversity to transmit data in both uplink (UL) and downlink (DL) directions. The obtained spatial diversity increases the capacity of the network dramatically, or equivalently one can say that it offers a more efficient utilization of the frequency spectrum. Moreover, MIMO can reduce the inter-cell and intra-cell interferences which in turn, leads to more frequency re-use. As the electromagnetic spectrum is a rare resource, MIMO is a vital solution for the extension of the capacity of wireless communication systems. A revolutionary technic for the new generation of communication networks (e.g., 5G network) compared to the previous communication network is the deployment of massive MIMO system by a large number of antennas installed at the network device, which provides enriched spatial domain multiplexing gain to the communication networks.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

A network device may comprise a radio unit and a baseband unit communicated with each other via a fronthaul interface. The radio unit obtains received signals at the antenna system and process the signals. The processed signals are passed to the baseband unit for baseband-related operations via the fronthaul interface. There exists bandwidth constraints on the bandwidth of the fronthaul interface, such that the number of bits passing through the fronthaul interface is limited. In the MIMO communications, with the increased number of antennas in the antenna system, the number of digital bits received from all antenna branches are increasing correspondingly, which creates a high requirement on the interface between the radio unit and the baseband unit.

According to some dimension reduction solutions, the received high dimensional signal is projected to the reduced dimensional space by beam-space transformation in the radio unit. However, those solutions rely on the beam space reduction. Due to the complexity limitation at the radio unit, only time-domain signal samples are received to design the beam space reduction. By this means, it is not feasible to design frequency selective beamforming. The beamforming quality is compromised. For some systems relying on the band pass filtering on the time domain samples, the said band pass filtering may induce significant processing delay, which may serve as a critical issue in practice.

To overcome or mitigate at least one of the above-mentioned problems or other problems or provide a useful solution, embodiments of the present disclosure propose methods, devices and storage medium.

In a first aspect of the present disclosure, there is provided a method implemented at a radio unit. The method comprises obtaining a reference signal received at a first number of antenna elements from a terminal device, signal samples of the received reference signal being organized into the first number of sample sets along a spatial dimension; compressing the received reference signal along the spatial dimension, to obtain a compressed reference signal, signal samples of the compressed reference signal being organized into a second number of sample sets along the spatial dimension, the second number being less than the first number; and transmitting the compressed reference signal to a baseband unit via a fronthaul interface.

In some embodiments, the compressing the received reference signal comprises: generating a compression precoder matrix, elements of the compression precoder matrix being organized into the second number of element sets along the spatial dimension; and performing a combination of the compression precoder matrix and the received reference signal, to generate the compressed reference signal.

In some embodiments, the compression precoder matrix is randomly generated. In some embodiments, the compression precoder matrix is generated based on a normal distribution.

In some embodiments, the radio unit and the baseband unit are comprised in a network device communicated with the terminal device.

In some embodiments, the reference signal comprises a sounding reference signal.

In a second aspect of the present disclosure, there is provided a method implemented at a baseband unit. The method comprises: receiving a compressed reference signal from a radio unit via a fronthaul interface, the compressed reference signal being generated from a reference signal received at a first number of antenna elements from a terminal device, signal samples of the compressed reference signal being organized into a second number of sample sets along a spatial dimension, the second number being less than the first number; and determining a channel estimate for the terminal device and a network device by reconstructing on the compressed reference signal, the network device comprising the baseband unit and the radio unit, the channel estimate indicating the first number of receiving branches at the network device.

In some embodiments, the reconstructing on the compressed reference signal is based on a compression precoder matrix, the compression precoder matrix being used to generate the compressed reference signal at the radio unit.

In some embodiments, determining the channel estimate comprises: determining a compressed channel estimate based on the compressed reference signal, the compressed channel estimate indicating the second number of receiving branches; and performing channel reconstruction from the compressed channel estimate, to obtain the channel estimate.

In some embodiments, performing the channel reconstruction comprises: applying an orthogonal match pursuit (OMP) on the compressed channel estimate, to obtain the channel estimate.

In some embodiments, the compressed reference signal is in a time-domain compressed reference signal, and determining the compressed channel estimate comprises: performing time-to-frequency domain transformation on the time-domain compressed reference signal, to obtain a frequency-domain compressed reference signal; and determining the compressed channel estimate based on the frequency-domain compressed reference signal.

In some embodiments, the channel estimate comprises channel estimate information corresponding to a plurality of subcarriers, the method further comprising: determining a frequency-dependent precoder for a given subcarrier of the plurality of subcarriers based on channel estimate information corresponding to the given subcarrier.

In some embodiments, the method further comprises: determining, based on the channel estimate, beamforming information for at least one of an uplink reception from the terminal device to the network device or a downlink transmission from the network device to the terminal device.

In a third aspect of the present disclosure, there is provided a radio unit. The radio unit comprises a processor; and a memory, said memory containing instructions executable by said processor, whereby said radio unit is operative to: obtain a reference signal received at a first number of antenna elements from a terminal device, signal samples of the received reference signal being organized into the first number of sample sets along a spatial dimension; compress the received reference signal along the spatial dimension, to obtain a compressed reference signal, signal samples of the compressed reference signal being organized into a second number of sample sets along the spatial dimension, the second number being less than the first number; and transmit the compressed reference signal to a baseband unit via a fronthaul interface.

In some embodiments, the radio unit may be further operative to implement the method according to the first aspect.

In a fourth aspect of the present disclosure, there is provided a baseband unit. The baseband unit comprises a processor; and a memory, said memory containing instructions executable by said processor, whereby said baseband unit is operative to: receive a compressed reference signal from a radio unit via a fronthaul interface, the compressed reference signal being generated from a reference signal received at a first number of antenna elements from a terminal device, signal samples of the compressed reference signal being organized into a second number of sample sets along a spatial dimension, the second number being less than the first number; and determine a channel estimate for the terminal device and a network device by reconstructing on the compressed reference signal, the network device comprising the baseband unit and the radio unit, the channel estimate indicating the first number of receiving branches at the network device.

In some embodiments, the baseband unit may be further operative to implement the method according to the second aspect.

In a fifth aspect of the present disclosure, there is provided a network device. The network device comprises the radio unit operative to implement the method according to the first aspect; and the baseband unit operative to implement the method according to the second aspect.

In a sixth aspect of the present disclosure, there is provided an apparatus. The apparatus comprises means for performing the method according to the first or second aspect.

In a seventh aspect of the disclosure, there is provided a computer-readable storage medium having instructions stored thereon, the instructions, which, when executed by at least one processor of a device, cause the device to perform the method according to the first or second aspect.

With the present disclosure, by adopting spatial-domain signal compression in the radio unit on top of reference signal, the compressed reference signal can be passed from radio unit to the baseband unit with interface constraints and it can reduce the complexity in the radio unit. Further, the proposed solution can guarantee that the frequency-dependent channel state information can be reconstructed based on the compressed data at baseband. By this means, the proposed solution can provide flexibility for subsequent beamforming based on hardware limitation.

### BRIEF DESCRIPTION OF THE DRAWINGS

Through the more detailed description of some embodiments of the present disclosure in the accompanying drawings, the above and other objectives, features and advantages of the present disclosure will become more apparent, wherein the same reference generally refers to the same components in the embodiments of the present disclosure.

FIG. 1 is a diagram showing an example communication environment in which embodiments of the present disclosure can be implemented.

FIG. 2 is a schematic diagram of a network device in accordance with some embodiments of the present disclosure.

FIG. 3 is a schematic diagram of a network device showing example detailed structures in accordance with some embodiments of the present disclosure.

FIG. 4 is a diagram showing a flowchart of an example process of signal processing in accordance with some embodiments of the present disclosure.

FIGS. 5A-5C illustrate some simulation results based on the proposed solution in accordance with some embodiments of the present disclosure.

FIG. 6 is a diagram showing a flowchart of an example method implemented at a radio unit in accordance with some embodiments of the present disclosure.

FIG. 7 is a diagram showing a flowchart of an example method implemented at a baseband unit in accordance with some embodiments of the present disclosure.

FIG. 8 is a block diagram showing a communication device in accordance with some embodiments of the present disclosure.

FIG. 9 is a block diagram showing a computer readable storage medium in accordance with some embodiments of the present disclosure.

FIG. 10 is a block diagram showing an example of a communication system in accordance with some embodiments of the present disclosure.

FIG. 11 is a block diagram showing a network node in accordance with some embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The “terminal device” can further have “multicast/broadcast” feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network node” may also be referred to as a network function (NF), a network entity, or a network device, and refers to a physical, virtual or hybrid function or entity which is deployed at a network side and provides one or more services to clients/consumers. For example, an NF may be arranged at a device in a radio access network (RAN) or a core network (CN) of a communication system. The network node may be implemented in hardware, software, firmware, or some combination thereof. Examples of a network node in a RAN include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an JAB node, a low power node such as a femto node, a pico node, a reconfigurable intelligent surface (RIS), and the like. Examples of a network node in a CN include, but not limited to, a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communications in a communication environment may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the third generation (3G), the fourth generation (4G), 4.5G, the fifth generation (5G) communication protocols, 5.5G, 5G-Advanced networks, or the sixth generation (6G) networks and beyond and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

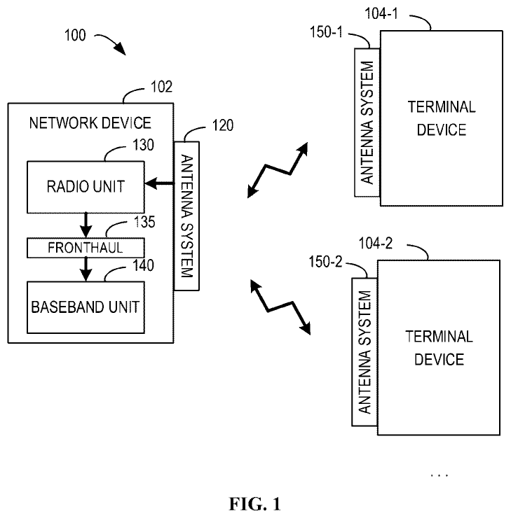

FIG. 1 illustrates an example communication environment 100 in which example embodiments of the present disclosure can be implemented. As shown in FIG. 1, the communication environment 100 may include a network device 102 and one or more terminal devices such as terminal devices 104-1, 104-2, which can communicate with each other. For the purpose of discussion, the terminal devices 104-1, 104-2 are collectively or individually referred to as terminal devices 104.

Communications in the communication environment 100 may be implemented according to any proper communication protocols and technologies. It is to be understood that the numbers of devices are illustrated in FIG. 1 only for the purpose of illustration without suggesting any limitations. The communication environment 100 may include any suitable numbers of devices for implementing embodiments of the present disclosure. In an example, there may be a plurality of terminal devices communicated with the network device 102, and there may be more than one network device in the communication environment 100. It is also to be understood that the devices as illustrated in FIG. 1 are only examples. Other devices may also be involved in the environment 100.

The network device 102 is equipped with an antenna system 120, which includes a plurality of antenna elements. The terminal device 104-1 is equipped with an antenna system 150-1, and the terminal device 104-2 is equipped with an antenna system 150-2. The antenna systems 150-1, 150-2 each may include one or a plurality of antenna elements. The antenna system 120 of the network device 102 includes antenna elements to receive signals transmitted from the antenna system(s) 150 of one or more terminal devices 104. The antenna system 120 may also include antenna elements to transmit signals to the antenna system(s) 150 of one or more terminal devices 104.

The network device 102 further includes a radio unit (RU) 130, such as a remote radio unit (RRU), and a baseband unit (BBU) 140. The radio unit 130 obtains received signals from the antenna system 120 and provides signals to be transmitted to the antenna system 120. The radio unit 130 can, for example, provide the analog radio frequency functions, and the baseband unit 140 can, for example, provide the radio functions of the digital baseband domain. The radio unit 130 and the baseband unit 140 can communicate with each other via a physical communication interface, referred to as a fronthaul interface 135 (or C1 interface).

In some embodiments, the antenna system 120 may be an advanced antenna system (AAS) which is a combination of an AAS radio and a set of AAS features. An AAS radio consists of an antenna array closely integrated with the hardware and software required for transmission and reception of radio signals, and signal processing algorithms to support the execution of the AAS features. Compared to conventional antenna systems, this AAS provides much greater adaptivity and steerability, in terms of adapting the antenna radiation patterns to rapidly time-varying traffic and multi-path radio propagation conditions. In addition, multiple signals may be simultaneously received or transmitted by the ASS with different radiation patterns.

With the increased number of antennas in the antenna system, some issues arise such as hardware complexity, power amplifier (PA) quality/cost, and the co-design of radio and baseband units. For the legacy antenna system with a small number of antenna elements, the total amount of information passing (e.g., Fast Fourier Transform (FFT) and Inverse Fast Fourier Transform (IFFT)) through the antenna branches and the baseband units are limited. Therefore, frequency selective digital beamforming in the network device is supported by transformation processing of the signal received at each antenna element. However, with the increase of the number of antenna elements, the number of digital bits received from all antenna branches are increasing correspondingly, which creates a high requirement on the interface between the radio unit and the baseband unit (e.g., via the fronthaul interface). In most of the practical AAS system, there exists bandwidth constraints on the bandwidth of the fronthaul interface, such that the number of bits passing through the fronthaul interface is limited. For mmWave-based communication systems, due to the small wavelength and high path loss of wireless channels, even a large number of antenna elements are possible to be integrated into the AAS system, to meet the fronthaul interface bandwidth limitation, data compression techniques are required to apply on the received data before passing to the baseband unit.

Considering the fact that in a practical deployment scenario, the number of propagation paths received from the uplink (UL) channels is generally much smaller than the total number of receiving antenna elements, dimension reduction in the spatial domain seems to be feasible, where the received signal with high dimensions can be projected to a lower dimensional space while still keeping the essential information.

According to some dimension reduction solutions, the received high dimensional signal is projected to the reduced dimensional space by beam-space transformation in the radio unit. The beam space is spanned by the pre-defined spatial vectors, such as Discrete Fourier Transform (DFT) matrix-based beam space or singular value decomposition (SVD) precoder, or by the adaptive beam space which depends on the channel state information estimated from the UL reference signals. The dimension reduction may be achieved by selecting the strongest beam direction based on some design criterion.

However, those solutions rely on the beam space reduction. Due to the complexity limitation at the radio unit, only time-domain signal samples are received to design the beam space reduction, e.g., analog beam forming or wideband beam forming. By this means, it is not feasible to design frequency selective beamforming. The beamforming quality is compromised. For some systems relying on the band pass filtering on the time domain samples, the said band pass filtering may induce significant processing delay, which may serve as a critical issue in practice.

Other hardware architectures supporting transformation processing at the radio unit make it possible to resolve the frequency-dependent channel state information based on reference signal reception. However, this solution may not be feasible for the antenna system with a large number of antenna elements considering the hardware cost and complexity.

Certain aspects of the disclosure and their embodiments may provide solutions to these or other challenges. Some embodiments of the present disclosure propose an improved signal processing solution for a network device.

Specifically, a signal compression mechanism is applied at a radio unit of the network device, which compresses the received reference signal from antenna elements of an antenna system. The reference signal is compressed along a spatial dimension in such a way that the spatial dimensions of the compressed reference signal are lower than the spatial dimensions of the received reference signal (which is equal to the number of the receiving antenna elements). The compressed reference signal can be passed from radio unit to the baseband unit with interface constraints. By adopting spatial-domain signal compression in the radio unit on top of reference signal, it can reduce the number of antenna or processing parallels.

Further, the compressed reference signal can also be used to reconstruct the propagation channel between the terminal device and the network device, i.e. a channel estimate indicating the same number of receiving branches (receiving antenna elements) at the network device. As a result, the proposed solution can guarantee that the frequency-dependent channel state information can be reconstructed based on the compressed data at baseband. By this means, the proposed solution can provide flexibility for subsequent beamforming based on hardware limitation.

Some example implementations will be described below with reference to the accompanying drawings.

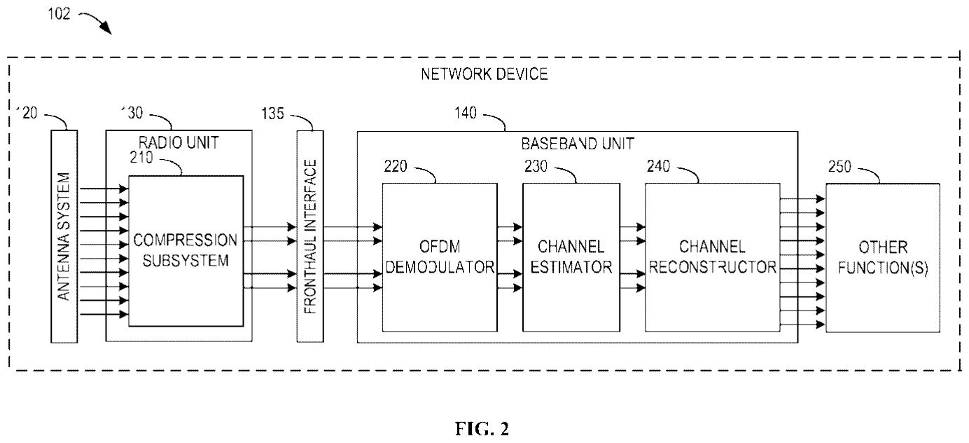

FIG. 2 is a schematic diagram of a network device in accordance with some embodiments of the present disclosure. For the purpose of illustration, reference is made to the network device 102 in the communication environment 100 of FIG. 1.

As shown in FIG. 2, the radio unit 130 of the network device 102 obtains a reference signal received at the antenna system 120. The reference signal is transmitted from the terminal device 104. The terminal device 104 may include a reference signal transmission module which may follow a typical reference signal transmission mechanism as specified in the communication environment 100 (e.g., from the current standards or even the future standards). As an example, the network device 102 may configure the terminal device 104 to transmit an UL reference signal at the allocated time-frequency resource grids.

It is assumed that the antenna system 120 includes a first number of antenna elements for signal reception, also referred to as a fist number of receiving antenna elements. The signal samples of the received reference signal can organized into a number of sample sets along a spatial dimension, where the number of the sample sets is equal to the first number. As will be discussed in the following embodiments, the reception of the reference signal is for the purpose of channel estimation between the network device 102 and the terminal device 104. Thus, in some embodiments, the reference signal may include a sounding reference signal (SRS), although other types of reference signals used for channel estimation are also applicable.

The radio unit 130 in the network device 102 includes a compression subsystem 210. The compression subsystem 210 is configured to compress the received reference signal along the spatial dimension, to obtain a compressed reference signal. The signal compression in the radio unit 130 is to reduce the number of processing parallels in the spatial domain (also referred to as an antenna domain). Accordingly, signal samples (also referred to as signal symbols) of the compressed reference signal are organized into a second number of sample sets along the spatial dimension, the second number being less than the first number. That is, the antenna or processing parallels along the spatial (antenna) domain are reduced. In some examples, the second number may be configured to be much lower than the first number. The second number may be configured as any reasonable value based on the first number of antenna elements used for receiving the reference signal and the interface constraints on the fronthaul interface.

In some embodiments, the signal compression is implemented at the radio unit 130 before the OFDM demodulation (which is typically implemented at the baseband unit). The signal compression may focus on the compression of the signal received at the UL reference signal symbols.

The radio unit 130 can transmit the compressed reference signal to the baseband unit 140 via the fronthaul interface 135. As the number of dimensions are reduced, the interface constraints can be bypassed. Compared with the complex beam space reduction in conventional solutions, the proposed signal compression solution renders low complexity at the radio unit.

The signal compression at the compression subsystem 210 includes compressed sensing (also known as compressive sensing, compressive sampling, or sparse sampling) which is a signal processing technique for efficiently acquiring and reconstructing a signal, by finding solutions to underdetermined linear systems. From the Nyquist-Shannon sampling theorem, if the highest frequency of a signal is less than half of the sampling rate, then the signal can be reconstructed perfectly. It is expected that the compressed reference signal can be reconstructed into the original received reference signal in order to estimate the actual channel between the terminal device 104 and the network device 102. The inventors have found that compressed sensing makes it possible to reconstruct the received signal at the network device even though the Nyquist-Shannon sampling theorem fails to hold, which means that the signal highest frequency is more than half of the sampling rate. In other words, if the signal is sparse, or sparse after being transferred into another domain, it is possible to reconstruct it after compressing it by compressed sensing with a certain dictionary.

In this way, the compression subsystem 210 in the radio unit 130 of the network device 102 can compress the received signal from the receiving antenna elements at the antenna system (e.g., an AAS frontend). In some embodiments, the signal compression may be performed by a sampling method which creates a number of linear combinations of the received reference signal from the antenna elements. The number of the linear combinations may be less than the number of the receiving antenna elements. In some embodiments, the signal compression may be applied on the time intervals when the reference signals are transmitted from the terminal device(s). The compressed reference signal may be transmitted to the baseband unit 140 via the fronthaul interface 135 which may have bandwidth constraints.

As shown in FIG. 2, the baseband unit 140 includes an OFDM demodulator 220, a channel estimator 230, and a channel reconstructor 240. In some embodiments, the received reference signal and thus the compressed reference signal comprises OFDM modulated signal samples. Thus, upon receipt of the compressed reference signal from the radio unit 130, the OFDM demodulator 220 is configured to perform OFDM demodulation on the compressed reference signal. The channel estimator 230 and the channel reconstructor 240 work together to reconstruct a channel estimate with a certain resolution from the compressed reference signal after the OFDM demodulation. The reconstruction on the compressed reference signal may work before or after the channel estimation, which may be a design choice.

In the following embodiments, for the purpose of discussion, the reconstruction is performed after the channel estimation. The channel estimator 230 may determine a compressed channel estimate based on the compressed reference signal. Without the signal reconstruction, the compressed channel estimate indicates the reduced second number of receiving branches at the network device 102. The channel estimator 230 may adopt any suitable channel estimation algorithms to derive the channel state information from the compressed reference signal. The channel reconstructor 240 may then perform channel reconstruction from the compressed channel estimate, to obtain the channel estimate.

The channel estimate can indicate channel state information for the network device 102 and the terminal device 104 and specifically indicate the first number of receiving branches at the network device 102. That is, although the received reference signal is compressed along the spatial domain into a lower resolution, it is still possible to reconstruct the actual receiving branches (corresponding to the number of antenna elements receiving the reference signal) at the network device 102. With the number of transmitting antenna elements at the terminal device 104 known, the accurate channel estimate for the network device 102 and the terminal device 104 can thus be determined.

In some embodiments, sparse signal reconstruction algorithms may be adopted to reconstruct the compressed reference signal (or the compressed channel estimate) to the desired resolution. Accordingly, frequency-dependent channel state information may be reconstructed at the baseband unit based on the compressed reference signal. By this means, the proposed solution can further provide flexibility for the beamforming design based on hardware limitation.

The network device 102 may further include other function(s) 250 subsequent to the baseband unit 140. The other function(s) 250 can operate based on the channel estimate from the baseband unit 140. For example, the subsequent receiving and transmission precoding/beamforming procedures may be performed for the following UL physical channel reception and DL physical channel transmission, respectively, based on the reconstructed channel estimate.

In some embodiments, the other function(s) 250 may include a beamformer which is configured to perform subsequent beamforming procedures for coherent transmission and reception, to achieving better system throughput. Specifically, the beamformer may determine, based on the channel estimate from the baseband unit 140, beamforming information. The other function(s) 250 may further include other modules for UL reception from the terminal device 104 to the network device 102 and/or DL transmission from the network device 102 to the terminal device 104 based on the beamforming information.

According to the embodiments of the present disclosure, the signal compression in the radio unit 130 can significantly reduce the processing parallels for the fronthaul interface (i.e., the C1 interface). The channel estimation complexity and cost are transformed to the baseband unit 140, which is generally more viable. At the same time, compared to the conventional solutions which use the DFT-based or SVD precoder in the radio unit to reduce the parallels and thus only wideband information is kept from the channel state information, the proposed solution according to the embodiments can impose no such limitations because of the corresponding channel reconstructor in the baseband unit. Furthermore, the proposed signal compression (or random sampling) can be operated in the time domain, and thus there is no need to implement the OFDM demodulator or bandlimited filter in the radio unit which can further reduce the hardware complexity.

The proposed signal compression solution can thus introduce system design flexibility such that both frequency-dependent precoder and wideband precoder can be derived from the reconstructed channel estimate in the baseband unit.

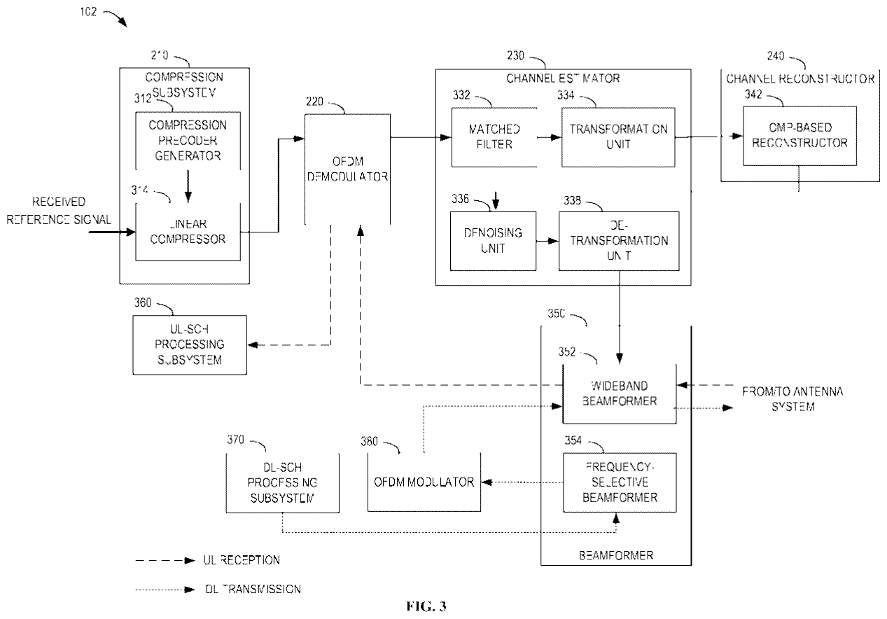

To better understand the signal compression and reconstruction in the radio unit and the baseband unit, and other functions in the network device, reference is made to FIG. 3 which shows the network device 102 showing example detailed structures therein.

As shown in FIG. 3, the compression subsystem 210 in the radio unit 130 includes a compression precoder generator 312 and a linear compressor 314. The compression precoder generator 312 is configured to generate a compression precoder matrix for signal compression of the received reference signal. In some embodiments, the compression precoder matrix may be randomly generated. In some embodiments, the compression precoder matrix is generated based on a normal distribution. For example, the compression precoder matrix may be a matrix which entries are normally distributed. In some examples, the compression precoder matrix may also be referred to as a measurement matrix (MM), which may be an underdetermined matrix. The linear compressor 314 is configured to perform the signal compression on the received reference signal, by performing a combination of the compression precoder matrix and the received reference signal, to generate the compressed reference signal.

Let [·] following a matrix denotes the size of the matrix, and the superscripts * and T denote conjugate transposition and transposition, respectively. It is assumed that the received signal samples (e.g., OFDM samples) for a certain SRS port can be represented as R [Nᵣₓ×Nₛ], where Nᵣₓ denotes the first number of receiving antenna elements at the antenna system 120 and Nₛ denotes the number of signal samples in the OFDM symbol where SRS is transmitted, respectively. It can be seen that by dividing the signal samples of the received reference signal along the spatial dimension, there may result in the first number of sample sets, each set having Nₛ signal samples. Typically, Nₘ≤Nᵣₓ, and in some examples, Nₘ may be configured as much smaller than Nᵣₓ.

The compression precoder generator 312 provides an underdetermining compression precoder matrix Φ [Nₘ×Nᵣₓ], or so-called measurement matrix. Elements of the compression precoder matrix are organized into the second number Nₘ of element sets along the spatial dimension, each set having Nᵣₓ elements. The linear compressor 314 may adopt the compression precoder matrix for signal compression on the received reference signal as follows:

$$\tilde{R} = Φ R \qquad ( 1 )$$

where \tilde{R} is the compressed reference signal, with a size of [Nₘ×Nₛ]. It can be seen that by dividing the signal samples of the compressed reference signal along the spatial dimension, there may result in Nₘ sample sets, each set having Nₛ signal samples. There are multiples ways to generate the compression precoder matrix Φ, such as but not limited to a matrix which entries are normally distributed.

The compressed reference signal is passed to the baseband unit 140 via the fronthaul interface 135. After OFDM demodulation on \tilde{R} by the OFDM demodulator 220 in the baseband unit 140, the measured signal samples in the compressed reference signal is represented as Y[Nₘ×N_{freq}], where N_{freq} denotes the number of signal samples in the frequency domain. Y can be used to determine a channel estimate H[Nᵣₓ×N_{freq}] from the compressed reference signal, given as:

$$Y = Φ Hs + n \qquad ( 2 )$$

where s[N_{freq}×1] is the pilot sequence of the reference signal transmitted from the terminal device 102, and n is the noise, for example, the Additive White Gaussian noise. The compression precoder matrix Φ, which is used to generate the compressed reference signal at the radio unit, is also taken into account.

For a certain subcarrier f, the expression in Equation (2) can be written as:

$${y}_{f} = Φ {h}_{f} {s}_{f} + e \qquad ( 3 )$$

where y_{f} and h_{f} is the f-th column of the matrix Y and H, respectively, s_{f} is the f-th element of s with

$${s}_{f} {s}_{f}^{*} = 1 ,$$

and e is a random value caused by the noise.

In some embodiments, the compressed reference signal is in a time-domain compressed reference signal. In some embodiments, the reconstruction in the baseband unit 140 may be embedded into a transform-based channel estimator such as FFT/DCT-based channel estimator. It is worth noting that the transformation may be other types of invertible transformation with orthogonal basis. In the following, the notation D is used to denote an invertible transformation. The baseband unit 140 may perform time-to-frequency domain transformation on the time-domain compressed reference signal, to obtain a frequency-domain compressed reference signal, and determine the compressed channel estimate based on the frequency-domain compressed reference signal.

The channel estimator 230 in the baseband unit 140 may include a matched filter 332, a transformation unit 334, a denoising unit 336, and a de-transformation unit 338. The matched filter 332 is configured to perform matched filtering on the compressed reference signal. The received and compressed channel estimate after the matched filtering can be written as follows:

$${\tilde{h}}_{f} = {y}_{f} {s}_{f}^{H} = Φ {D}^{H} {λ}_{f} + e {s}_{f}^{H} \qquad ( 4 )$$

where D[Nᵣₓ×Nᵣₓ] is a DFT matrix and the superscript H means the conjugate transpose of a matrix.

Let \tilde{H}[Nₘ×N_{freq}]=[\tilde{h}₁ \tilde{h}₂ . . . \tilde{h}_{N}_{_{freq}}] represent the compressed channel estimate in the frequency domain. As compared with the desired channel estimate H[Nᵣₓ×N_{freq}] with the first number of receiving branches Nᵣₓ, the compressed channel estimate \tilde{H}[Nₘ×N_{freq}] indicates the second number of receiving branches, Nₘ.

Before transformation at the transformation unit 334, a delay compensation may be applied to the compressed channel estimate in the frequency domain, given as:

$$\dot{H} [ {N}_{m} \times {N}_{f r e q} ] ( : , f ) = \tilde{H} ( : , f ) {e}^{j 2 π f {f}_{Δ} \hat{τ}} \qquad ( 5 )$$

where fΔ is the subcarrier spacing for the reference signal, and \hat{τ} is the estimated delay.

The transformation unit 334 is configured to perform DCT on the second dimension of \dot{H} for denoising, which may be expressed as:

$$\ddot{H} [ {N}_{m} \times {N}_{t a p} ] ( m , : ) = dct ( \dot{H} ( m , : ) ) \qquad ( 6 )$$

The transformation unit 334 provides the compressed and denoised channel estimate \dot{H} to the channel reconstructor 240. The channel reconstructor 240 can perform channel reconstruction from the compressed channel estimate, to obtain the channel estimate.

In some embodiments, the channel reconstructor 240 comprises an orthogonal match pursuit (OMP)-based reconstructor 342, which is configured to apply OMP on the compressed channel estimate, to reconstruct the desired channel estimate from the spatial domain of the compression precoder matrix to the original spatial domain of the received reference signal, which may be represented as follows:

$$\overline{\overline{H}} = [ {N}_{rx} \times {N}_{t a p} ] ( : , t ) = \{ \begin{matrix}omp ( \ddot{H} ( : , t ) ) & t \leq {T}_{max} \\ 0 & t > {T}_{max}\end{matrix} \qquad ( 7 )$$

where Tₘₐₓ denotes the configured maximal window length in OMP. The detailed embodiments of OMP-based reconstruction will be discussed in detail below.

The reconstructed channel estimate H̅ is provided to a denoising unit 336 in the channel estimator 230. The denoising unit 336 may be configured to apply a window on H̅ to filter noise, which may be represented as follows:

$${H}^{...} [ {N}_{rx} \times {N}_{tap} ] ( m , : ) = filter ( \overline{\overline{H}} ( m , : ) ) \qquad ( 8 )$$

The de-transformation unit 338 is configured to perform de-transformation (e.g., IDCT and interpolation) on the filtered channel estimate [symbol] , which may be represented as follows:

$$\overline{H} [ {N}_{r x} \times K ] ( m , : ) = i d ct ( {H}^{\cdot \cdot \cdot } ( m , : ) ) \qquad ( 9 )$$

where K is the number of subcarriers.

In some embodiments, a time shift may be further added to H̅, as follows:

$$\hat{H} [ {N}_{r x} \times K ] ( : , k ) = \overline{H} ( : , k ) {e}^{- j 2 π {kf}_{Δ}^{′} \hat{τ}} \qquad ( 10 )$$

where

$${f}_{Δ}^{′}$$

is the subcarrier spacing. Ĥ is the final channel estimate for the terminal device 104 and the network device 102.

Some embodiments for the OMP-based reconstruction will now be discussed in detail. As is known that there are only some paths through which the signal can propagate from the terminal device 102 to the network device, it is obvious that the channel in the angular domain is sparse, which satisfies the requirement for compressed sensing for reconstructing signals.

H and h_{f} can be also expressed in the angular domain as Λ and λ_{f}, respectively, which can be determined as follows:

$$H = {D}^{H} Λ or {h}_{f} = {D}^{H} {λ}_{f} \qquad ( 11 )$$

Since λ_{f} is sparse, the problem of channel reconstruction in the OMP-based reconstructor 342 may be transformed into a problem of compressed sensing as follows:

$${\overline{\overline{h}}}_{k} = Φ {D}^{H} {\overline{\overline{λ}}}_{k} + \overline{\overline{e}} \qquad ( 12 )$$

where e̅ is the estimation error.

To obtain λ̅ₖ, the OMP-based reconstructor 342 may need to solve a question of Li minimalization with a quadratic constraint, given as

$$min {‖ {\overline{\overline{λ}}}_{k} ‖}_{1} \qquad ( 13 )$$

$$s . t . {‖ {\overline{\overline{h}}}_{k} - Φ {D}^{H} {\overline{\overline{λ}}}_{k} ‖}_{2} < ϵ$$

where ∈ may be the power of the estimation error.

The OMP-based reconstruction is an iterative procedure. For a certain frequency point k (where k is from 1 to N_{freq}), the initial residual r₀ can be set as r₀=h̅ₖ in the channel estimate H̅, the initial candidate index set Π₀ may be set as Π₀=Ø. For an iteration t during the optimization procedure, the (best) index ηₜ may be determined by:

$${η}_{t} = arg {max}_{{j = 1 , … , {N}_{ant}}_{j ∉ {Π}_{t - 1}}} \vert 〈 {r}_{t - 1} , {φ}_{j} 〉 \vert \qquad ( 14 )$$

where φⱼ is the j-th column of the matrix ΦD^{H}. If the maximum value occurs for multiple indexes, the tie will be broken deterministically.

The index set may be augmented (i.e., optimized) as Πₜ=Πₜ₋₁∪{ηₜ}, and the angular domain channel estimate \hat{λ}_{f,t} may be determined by solving a least square problem as follows:

$${\hat{λ}}_{k , t} ( i ∈ {Π}_{t} ) = arg {min}_{λ} {‖ {\overline{\overline{h}}}_{k} - {Ψ}_{{Π}_{t}} λ ‖}_{2} = {( {Ψ}_{{Π}_{t}} )}^{†} {\overline{\overline{h}}}_{k} \qquad ( 15 )$$

$${\hat{λ}}_{k , t} ( i ∉ {Π}_{t} ) = 0 \qquad ( 16 )$$

where Ψ=ΦD^{H}, Ψ_{Π}_{ₜ} means a new matrix in which the columns of Ψ_{Π}_{ₜ} are selected using the elements of Πₜ, and (Ψ_{Π}_{ₜ})^{†} means its Moore-Penrose pseudoinverse.

Then a residual rₜ at the iteration t can be calculated as:

$${r}_{t} = {r}_{t - 1} - {Ψ}_{{Π}_{t}} {\hat{λ}}_{k , t} \qquad ( 17 )$$

The above operations may be repeated until the configured maximum number of iterations s, and the channel estimate ĥₖ for the k-th frequency point in Ĥ may be derived as follows:

$${\hat{h}}_{k} = {D}^{H} {\hat{λ}}_{k , s} \qquad ( 18 )$$

The above may be repeated for all the N_{freq} frequency points, to obtain the channel estimate Ĥ[Nᵣₓ×K]. It would be appreciated that although the OMP-based reconstruction is described here, any other algorithms applicable for signal reconstruction in the compressed sensing may also be adopted, and the scope of the present disclosure is not limited in this regard.

In subsequent beamforming and coherent transmission, the channel estimate Ĥ[Nᵣₓ×K] may be used for UL and DL hybrid beamforming.

In some embodiments, the proposed signal compression and reconstruction solution can introduce system design flexibility such that both frequency-dependent precoder and wideband precoder can be derived from the reconstructed channel estimate in the baseband unit 140.

Specifically, the network device 102 may further include a beamformer 350 to determine beamforming information based on the channel estimate Ĥ[Nᵣₓ×K] for the UL reception and/or DL transmission. The channel estimate Ĥ[Nᵣₓ×K] in the channel estimator 230 of the baseband unit 140 includes channel estimate information corresponding to K subcarriers. The beamformer 350 may include a wideband beamformer 352 configured to determine a wideband precoder based on the channel estimate over the K subcarriers. The beamformer 350 may further include a frequency-selective beamformer 354 configured to determine a frequency-dependent precoder determined based on channel estimate information corresponding to each of the subcarriers.

In some embodiments, for the UL reception, the wideband beamformer 352 may determine a wideband reception precoder based on the channel estimate. In some embodiments, the derived wideband reception precoder may be applied on the subsequent reference signal reception and UL shared channel (UL-SCH) or physical uplink shared channel (PUSCH) reception so that the compression is achieved. The detailed implementation includes the following steps.

A channel covariance matrix may be generated based on the reconstructed channel estimate. One or more wideband precoders may be derived by the wideband beamformer 352 from the channel covariance matrix. In some embodiments, the one or more wideband precoders may only be composed by phases (such as analog precoder) or composed by both varying amplitudes and phases (such as digital precoder). The number of wideband precoders may be a design parameter.

The derived wideband precoder(s) to the subsequent slots for UL reception, including the reference signal reception and UL traffic reception (e.g., UL-SCH or PUSCH reception). For example, the derived wideband precoder(s) may be provided to the OFDM demodulator 220 which may perform OFDM demodulation on the received and compressed reference signal and the UL-SCH data. The demodulated UL-SCH data may be further provided to a UL-SCH processing subsystem 360 in the network device 102 for further processing.

By this means, the total number of parallel signals may be be compressed to the subspace spanned by the wideband precoder(s) so as to satisfy the bit-rate constraints between the radio unit 130 and the baseband unit 140 (e.g., the C1 interface). The compressed reference signal may be passed to the baseband unit 140. In this step, the number of subsequent slots which are applied to the wideband precoder(s) may be a design parameter.

In some embodiments, a frequency-dependent precoder may be determined based on the compressed channel information and consequently applied on the compressed UL-SCH reception in the baseband unit 140.

In some embodiments, the signal compression and channel reconstruction as described above may be periodically triggered. Accordingly, a new wideband precoder(s) and frequency-dependent precoder may be derived based on the newly derived channel estimate. The periodicity may be a design parameter. The frequency-dependent precoder may be updated every time when the new compressed channel estimate is available at the baseband unit 140.

For DL transmission from the network device 102 to the terminal device 104, the network device 102 comprises a DL-SCH processing subsystem 370 to provide DL traffic (e.g., DL-SCH or physical downlink shared channel (PDSCH) data). The DL traffic may be passed to the beamformer 350 for beamforming. In some embodiments, a two-step hybrid precoding scheme may be applied on the DL traffic, in which the derived wideband precoder(s) for the UL reception may serve as the DL transmission wideband precoder applied in the radio front, and correspondingly, frequency selective precoders may be determined by the frequency-selective beamformer 354 based on the reconstructed frequency-dependent channel estimate. An example implementation is described as follows.

A channel covariance matrix (averaged over ports and K subcarriers) may be derived from the reconstructed channel estimate Ĥ[Nᵣₓ×Nₜₓ×K], as follows:

$$\hat{R} = \frac{1}{K} {\sum }_{k} {\hat{H}}_{k} {\hat{H}}_{k}^{*} \qquad ( 19 )$$

where Nₜₓ is the number of transmitting antenna elements of the terminal device 104, and

$${\hat{H}}_{k} = \hat{H} ( : , : , k ) \qquad ( 20 )$$

A wideband precoder W_{wb}[N_{csirs_port}×Nᵣₓ] may be determined from \hat{R} as follows, using a certain algorithm g(·), such as SVD:

$${W}_{wb} = g ( \hat{R} ) \qquad ( 21 )$$

where N_{csirs_port} is the number of ports for channel state information-reference signal (CSI-RS).

The calculated wideband precoder may be used for both the PUSCH reception and PDSCH transmission.

Consequently, a frequency-dependent precoder W_{fd}[N_{layer}×N_{csirs_port}×N_{subband}] can be calculated from the efficient channel estimate for PDSCH hybrid beamforming, using a certain algorithm G(·), such as SVD. For a certain subband sbᵢ, it can be given as:

$${W}_{fd} ( : , : , {sb}_{i} ) = G ( {W}_{w b} \frac{1}{{K}_{s {b}_{i}}} {\sum }_{{k}_{s {b}_{i}}} {\hat{H}}_{{k}_{s {b}_{i}}} ) \qquad ( 22 )$$

where N_{layer} is the number of layers, k_{sb}_{ᵢ} means the k_{sb}_{ᵢ}-th subcarrier over K_{sb}_{ᵢ} subcarriers in the subband sbᵢ. The efficient precoder may be determined as W_{sb}_{ᵢ}=W_{fd}(:,:,sbᵢ)W_{wb}.

The resulting DL traffic from the frequency-selective beamformer 354 may be provided to an OFDM modulator 380 in the network device 102 for OFDM modulation. After the OFDM modulation, the wideband precoders in the wideband beamformer 352 are further applied and then the DL traffic may be transmitted to the terminal device 104 via the antenna system 120 of the network device 102.

It would be appreciated that although some embodiments for the UL reception and DL transmission based on the channel estimate are described above, the channel estimate may be utilized in any other ways for the communications between the terminal device 104 and the network device 102.

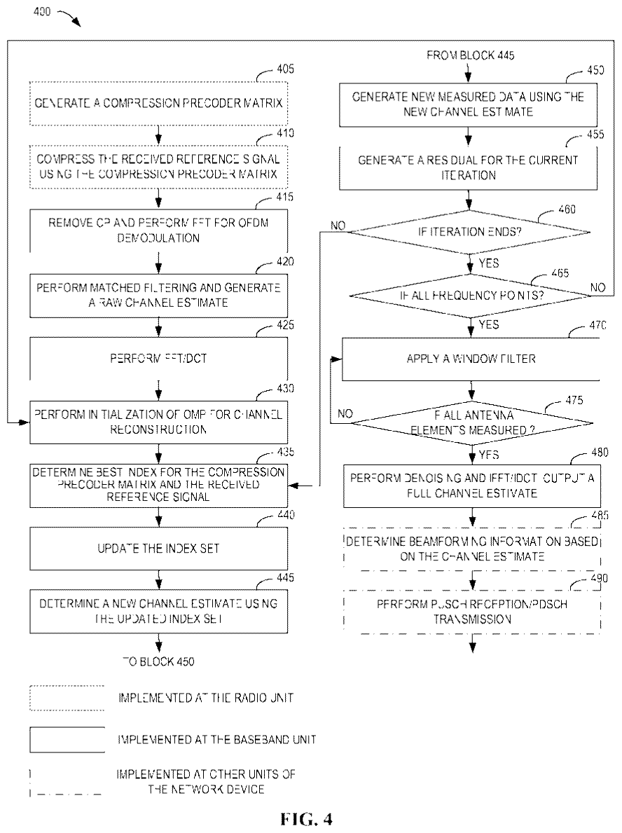

FIG. 4 shows a flowchart of an example process 400 of signal processing in accordance with some embodiments of the present disclosure. The process 400 involves the operations of the radio unit 130, the baseband unit 140, and other function(s) in the network device 102.

As shown in FIG. 4, at block 405, the radio unit 130 (e.g., the compression precoder generator 312 in the radio unit 130) generates a compression precoder matrix Φ [Nₘ×Nᵣₓ]. At block 410, the radio unit (e.g., the linear compressor 314 in the radio unit 130) compresses the received reference signal R [Nᵣₓ×Nₛ] using the compression precoder matrix Φ, to obtain the compressed reference signal \tilde{R}[Nₘ×Nₛ].

The compressed reference signal is transmitted to the baseband unit 140. At block 415, the baseband unit 140 (e.g., the OFDM demodulator 220) removes cyclic prefixes (CP) from the compressed reference signal and perform FFT for OFDM demodulation. The OFDM signal samples of the compressed reference signal \tilde{R} are transformed from the time domain to the frequency domain, represented as Y[Nₘ×N_{freq}].

At block 420, the baseband unit 140 (e.g., the matched filter 332 in the baseband unit 140) performs matched filtering on the compressed reference signa and generates a raw channel estimate (a compressed channel estimate \tilde{H}[Nₘ×N_{freq}]. At block 425, the baseband unit 140 (e.g., the transformation unit 334 in the baseband unit 140) performs time-to-frequency domain transformation, e.g., FFT/DCT, for the transformation-based denoising and estimation, to obtain the compressed and denoised channel estimate \ddot{H}[Nₘ×Nₜₐₚ].

Then the baseband unit 140 can perform channel reconstruction from the compressed channel estimate, to obtain the channel estimate. In some embodiments, the baseband unit 140 (e.g., the OMP-based reconstructor 342 in the baseband unit 140) performs OMP on the compressed channel estimate H̅, to generate channel estimate H̅[Nᵣₓ×Nₜₐₚ].

Specifically, at block 430, for a certain frequency point k, the baseband unit 140 (e.g., the OMP-based reconstructor 342 in the baseband unit 140) performs initialization of OMP for channel reconstruction, e.g., to set the initial residual

$${r}_{0} = {\overline{\overline{h}}}_{k} = {y}_{f} {s}_{f}^{H} ,$$

and the initial candidate index set Π₀=Ø. At block 435, for an iteration t, the baseband unit 140 (e.g., the OMP-based reconstructor 342 in the baseband unit 140) determines the best index ηₜ for the compression precoder matrix Φ and the received reference signal R. At block 440, the baseband unit 140 (e.g., the OMP-based reconstructor 342 in the baseband unit 140) updates the index set Πₜ=Πₜ₋₁∪{ηₜ}.

At block 445, the baseband unit 140 (e.g., the OMP-based reconstructor 342 in the baseband unit 140) determines a new channel estimate \hat{λ}_{f,t} (e.g., the angular domain channel estimate) using the updated index set Πₜ by solving a least square problem (e.g., in Equations (15)-(16)). At block 450, the baseband unit 140 (e.g., the OMP-based reconstructor 342 in the baseband unit 140) generates a new measured data by Ψ_{Π}_{ₜ}\hat{λ}_{f,t}. At block 455, the baseband unit 140 (e.g., the OMP-based reconstructor 342 in the baseband unit 140) generates a residual rₜ for the current iteration t, e.g., rₜ=rₜ₋₁−Ψ_{Π}_{ₜ}\hat{λ}_{f,t}.

At block 460, the baseband unit 140 (e.g., the OMP-based reconstructor 342 in the baseband unit 140) determines if the iteration ends, for example, if the number of iterations reaches the configured maximum number of iterations s. If the iteration does not end, the process 400 goes back to block 435. If the iteration ends, at block 465, the baseband unit 140 (e.g., the OMP-based reconstructor 342 in the baseband unit 140) determines if the reconstruction on all the N_{freq} frequency points (frequency samples) are done and obtain a full channel estimate ĥ_{f}=D*\hat{λ}_{f,s}.

If not all the frequency points are reconstructed, the process 400 goes back to block 430, to perform reconstruction on another frequency point. Otherwise, the process 400 proceeds to block 470, where the baseband unit 140 (e.g., the OMP-based reconstructor 342 in the baseband unit 140) applies a window filter for each antenna element (or beam), as in Equation (7). At block 475, the baseband unit 140 (e.g., the OMP-based reconstructor 342 in the baseband unit 140) determines if all antenna elements are measured. If so, the process 400 proceeds to block 480. Otherwise, the process 400 goes back to block 475. At block 480, the baseband unit 140 (e.g., the denoising unit 336 and the de-transformation unit 338 in the baseband unit 140) perform denoising and de-transformation, e.g., IFFT/IDCT, to output a full channel estimate Ĥ[Nᵣₓ×K].

In some embodiments, the operations from blocks 420 to 480 in the process 400 may be performed for channel estimation for each antenna element (parallel).

The full channel estimate Ĥ[Nᵣₓ×K] may be utilized in UL reception and DL transmission at the network device 102. In some embodiments, at the block 485, the network device (e.g., the beamformer 350 in the network device 102) may determine beamforming information based on the channel estimate, e.g., the wideband precoder and/or the frequency-dependent precoder. At block 490, the network device 102 (e.g., the UL-SCH processing subsystem 360 and/or the DL-SCH processing subsystem 370) may perform PUSCH reception and/or PDSCH transmission based on the beamforming information.

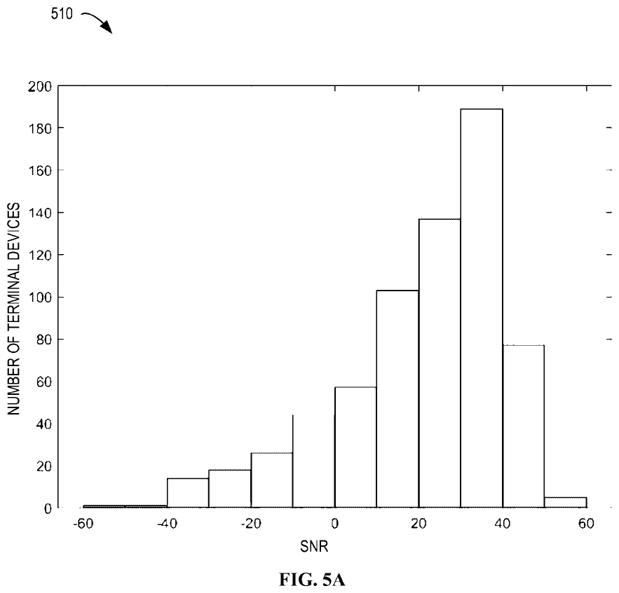

FIGS. 5A-5C illustrate some simulation results based on the proposed solution in accordance with some embodiments of the present disclosure. The simulation results were made in the link-level simulator and channel model. The simulation is coherent PDSCH transmission based the reconstructed. For the simulation purpose, eight beams are selected for W_{wb} derived by the DFT decomposition, consequently connected with W_{fd} derived by the wideband SVD. The histogram 510 of FIG. 5A illustrates the signal noise ratio (SNR) via the number of terminal devices. The curves 520 in FIG. 5B show the relationship between DL SNR of terminal devices and its throughput of coherent PDSCH transmission using the precoders derived by the reconstructed channel estimate. It is obvious that at DL SNR>−10 dB, the proposed solution with ½ compression rate (the compressed solution from 384 to 192 antenna parallels) gets the same the same throughput as the non-compressed solution with 384 antenna parallels. When the signal compression is set to a ⅙ compression rate (the compressed solution from 384 to 64 antenna parallels), at DL SNR>5 dB, the proposed solution can get the same throughput as the non-compressed solution.

In some cases, if the conditions of terminal devices are taken into consideration, as shown by the curves 540 in FIG. 5C, the proposed solution with ½ compression rate (the compressed solution from 384 to 192 antenna parallels) shows the similar cell throughput as the non-compressed case, which means the proposed solution can be used for most users with the same good performance. Some key results of FIG. 5C are shown in Table 1.

TABLE 1
Throughput for the proposed solution under different percentiles

| Percentile | 10% | 25% | 50% | 100% |
|---|---|---|---|---|
| 384, non- | 6.8 Mbps | 381 Mbps | 542 Mbps | 542 Mbps |
| compressed | | | | |
| 384 to 192, | 7.4 Mbps | 376 Mbps | 542 Mbps | 542 Mbps |
| compressed | | | | |
| 384 to 64, | 2.1 Mbps | 340 Mbps | 536 Mbps | 542 Mbps |
| compressed | | | | |

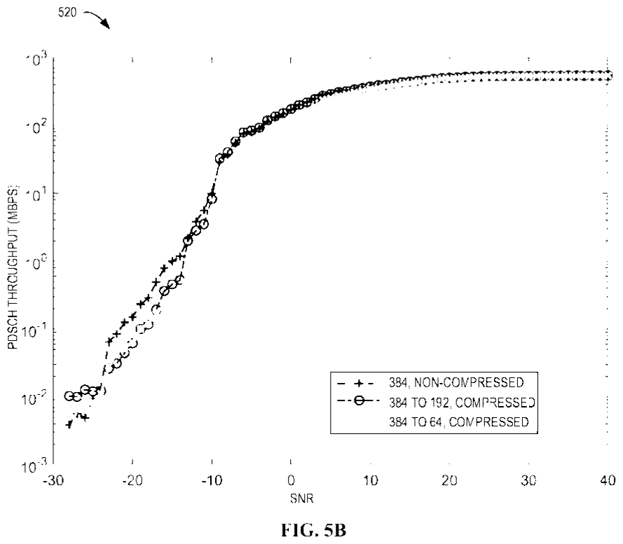

FIG. 6 shows a flowchart of an example method 600 implemented at a radio unit in accordance with some example embodiments of the present disclosure. The method 600 may be implemented by the radio unit 130 of the network device 102 as shown in FIG. 1, FIG. 2, or FIG. 3. For the purpose of discussion, the method 600 will be described from the perspective of the radio unit 130.

As shown in FIG. 6, at block 610, the radio unit 130 obtains a reference signal received at a first number of antenna elements from a terminal device 102. Signal samples of the received reference signal are organized into the first number of sample sets along a spatial dimension.

In some embodiments, the radio unit 130 and the baseband unit 140 are comprised in a network device 102 communicated with the terminal device 104.

In some embodiments, the reference signal comprises a sounding reference signal (SRS).

At block 620, the radio unit 130 compresses the received reference signal along the spatial dimension, to obtain a compressed reference signal. Signal samples of the compressed reference signal are organized into a second number of sample sets along the spatial dimension, and the second number is less than the first number.

In some embodiments, to compress the received reference signal, the radio unit 130 may generate a compression precoder matrix, elements of the compression precoder matrix being organized into the second number of element sets along the spatial dimension. The radio unit 130 may perform a combination of the compression precoder matrix and the received reference signal, to generate the compressed reference signal.

In some embodiments, the compression precoder matrix may be randomly generated. In some embodiments, the compression precoder matrix may be generated based on a normal distribution.

At block 630, the radio unit 130 transmits the compressed reference signal to a baseband unit 140 via a fronthaul interface 135.

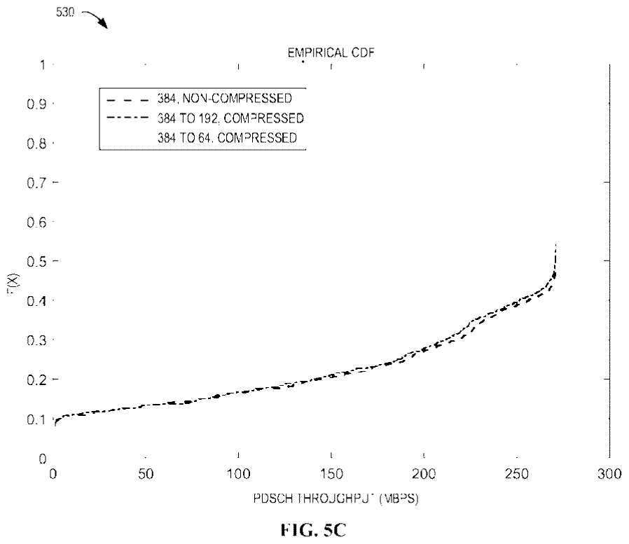

FIG. 7 shows a flowchart of an example communication method 700 in accordance with some example embodiments of the present disclosure. The method 700 may be implemented by the baseband unit 140 of the network device 102 as shown in FIG. 1, FIG. 2, or FIG. 3. For the purpose of discussion, the method 700 will be described from the perspective of the baseband unit 140.

As shown in FIG. 7, at block 710, the baseband unit 140 receives a compressed reference signal from a radio unit 130 via a fronthaul interface 135. The compressed reference signal is generated from a reference signal received at a first number of antenna elements from a terminal device 104. Signal samples of the compressed reference signal are organized into a second number of sample sets along a spatial dimension, and the second number is less than the first number.

At block 720, the baseband unit 140 determines a channel estimate for the terminal device 104 and a network device 102 by reconstructing on the compressed reference signal. The network device 102 comprises the baseband unit 140 and the radio unit 130, and the channel estimate indicates the first number of receiving branches at the network device.

In some embodiments, the reconstructing on the compressed reference signal may be based on a compression precoder matrix that is used to generate the compressed reference signal at the radio unit 130.

In some embodiments, the baseband unit 140 may determine a compressed channel estimate based on the compressed reference signal. The compressed channel estimate may indicate the second number of receiving branches. In some embodiments, the baseband unit 140 may perform channel reconstruction from the compressed channel estimate, to obtain the channel estimate.

In some embodiments, to perform the channel reconstruction, the baseband unit 140 may apply an orthogonal match pursuit (OMP) on the compressed channel estimate, to obtain the channel estimate.

In some embodiments, the compressed reference signal may be in a time-domain compressed reference signal, and accordingly, the baseband unit 140 may perform time-to-frequency domain transformation on the time-domain compressed reference signal, to obtain a frequency-domain compressed reference signal, and determine the compressed channel estimate based on the frequency-domain compressed reference signal.

In some embodiments, the channel estimate may comprise channel estimate information corresponding to a plurality of subcarriers. The baseband unit 140 may determine a frequency-dependent precoder for a given subcarrier of the plurality of subcarriers based on channel estimate information corresponding to the given subcarrier.

In some embodiments, the baseband unit 140 may further determine, based on the channel estimate, beamforming information for at least one of an uplink reception from the terminal device to the network device or a downlink transmission from the network device to the terminal device.

It would be appreciated that all operations and features related to the radio unit 130 and the baseband unit 140 as described above with reference to FIGS. 1 to 4 are likewise applicable to the methods 600 and 700 and have similar effects. For the purpose of simplification, the details will be omitted.

In an embodiment, the apparatus may further comprise means for implementing actions or operations related to the radio unit 130 according to any of the above-mentioned embodiments described with reference to FIGS. 1 to 7.

In some embodiments, an apparatus capable of performing the method 600 may comprise means for performing the respective operations of the method 600. The means may be implemented in any suitable form. For example, the means may be implemented in a circuitry or software module. The apparatus may comprise means for obtaining a reference signal received at a first number of antenna elements from a terminal device, signal samples of the received reference signal being organized into the first number of sample sets along a spatial dimension; means for compressing the received reference signal along the spatial dimension, to obtain a compressed reference signal, signal samples of the compressed reference signal being organized into a second number of sample sets along the spatial dimension, the second number being less than the first number; and means for transmitting the compressed reference signal to a baseband unit via a fronthaul interface.

In an embodiment, the apparatus may further comprise means for implementing actions or operations related to the radio unit 130 according to any of the above-mentioned embodiments described with reference to FIGS. 1 to 7.

In some embodiments, an apparatus capable of performing the method 700 may comprise means for performing the respective operations of the method 700. The means may be implemented in any suitable form. For example, the means may be implemented in a circuitry or software module. The apparatus may comprise means for receiving a compressed reference signal from a radio unit via a fronthaul interface, the compressed reference signal being generated from a reference signal received at a first number of antenna elements from a terminal device, signal samples of the compressed reference signal being organized into a second number of sample sets along a spatial dimension, the second number being less than the first number; and means for determining a channel estimate for the terminal device and a network device by reconstructing on the compressed reference signal, the network device comprising the baseband unit and the radio unit, the channel estimate indicating the first number of receiving branches at the network device.

In an embodiment, the apparatus may further comprise means for implementing actions or operations related to the baseband unit 140 according to any of the above-mentioned embodiments described with reference to FIGS. 1 to 7.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

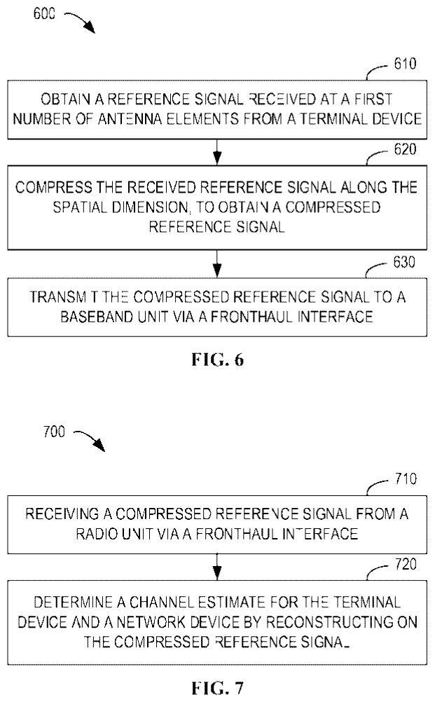

FIG. 8 shows a communication device 800 in accordance with some embodiments of the present disclosure. The communication device 800 may operate as either the radio unit 130, the baseband unit 140, or the network device 102 as shown in FIG. 1.

As shown in FIG. 8, the communication device 800 may comprise a processor 805 and a memory 810. The memory 810 may contain instructions 815 executable by the processor 805, whereby the communication device 800 may be operative to implement actions or operations related to the radio unit 130, the baseband unit 140, or the network device 102 according to any of the above-mentioned embodiments described with reference to FIGS. 1 to 7.

The processor 805 may be any kind of processing component, such as one or more microprocessor or microcontrollers, as well as other digital hardware, which may include digital signal processors (DSPs), special-purpose digital logic, and the like. The memory 810 may be any kind of storage component, such as read-only memory (ROM), random-access memory, cache memory, flash memory devices, optical storage devices, etc.

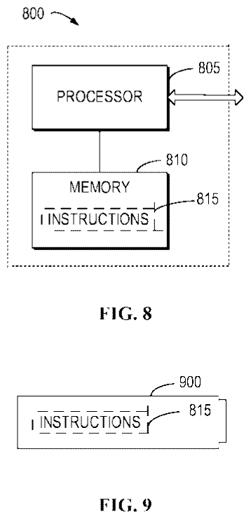

FIG. 9 shows a computer readable storage medium 900 in accordance with some embodiments.

As shown in FIG. 9, the computer readable storage medium 900 comprising instructions 815 which when executed by a processor of a device, cause the device to perform any above-mentioned embodiments described with reference to FIGS. 1 to 7.

The computer readable storage medium 900 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives.

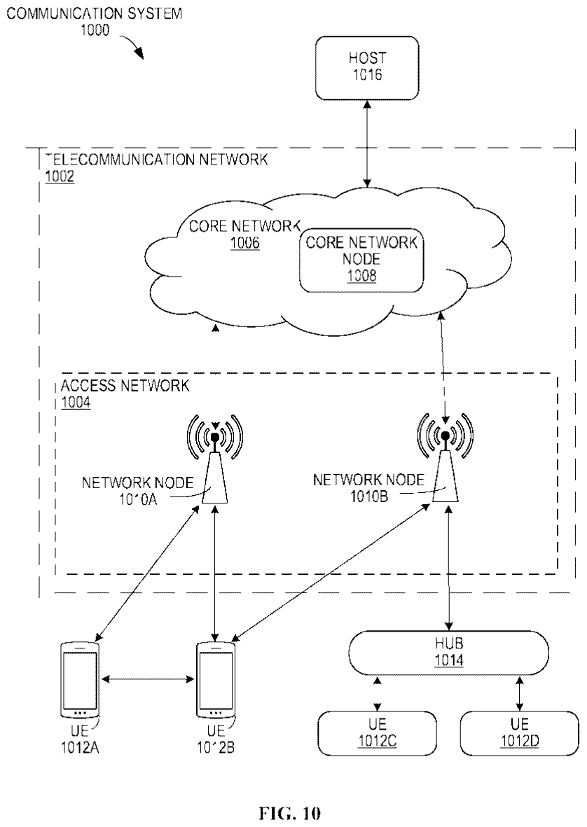

FIG. 10 shows an example of a communication system 1000 in accordance with some embodiments of the present disclosure.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010A and 1010B (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012A, 1012B, 1012C, and 1012D (one or more of which may be generally referred to as UEs 1012) to the core network 1006 over one or more wireless connections. In some embodiments, the first communication device 110 as shown in FIG. 1 may operate as a network node such as a router in the core network 1006.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

As used herein, a network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

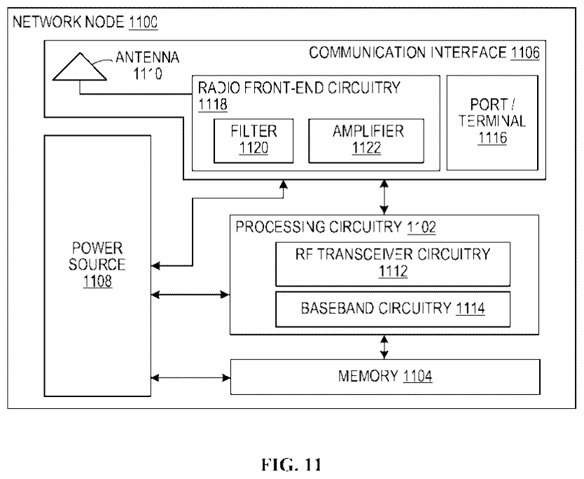

FIG. 11 shows a network node 1100 in accordance with some embodiments of the present disclosure. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Those skilled in the art will recognize improvements and modifications to the embodiments of the present disclosure. All such improvements and modifications are considered within the scope of the concepts disclosed herein.

1. A method implemented at a radio unit, comprising:
obtaining a reference signal received at a first number of antenna elements from a terminal device, signal samples of the received reference signal being organized into the first number of sample sets along a spatial dimension;
compressing the received reference signal along the spatial dimension, to obtain a compressed reference signal, signal samples of the compressed reference signal being organized into a second number of sample sets along the spatial dimension, the second number being less than the first number; and
transmitting the compressed reference signal to a baseband unit via a fronthaul interface.

2. The method of claim 1, wherein the compressing the received reference signal comprises:
generating a compression precoder matrix, elements of the compression precoder matrix being organized into the second number of element sets along the spatial dimension; and
performing a combination of the compression precoder matrix and the received reference signal, to generate the compressed reference signal.

3. The method of claim 2, wherein the compression precoder matrix is randomly generated.

4. The method of claim 3, wherein the compression precoder matrix is generated based on a normal distribution.

5. The method of claim 1, wherein the radio unit and the baseband unit are comprised in a network device communicated with the terminal device.

6. The method of claim 1, wherein the reference signal comprises a sounding reference signal.

7. A method implemented at a baseband unit, comprising:
receiving a compressed reference signal from a radio unit via a fronthaul interface, the compressed reference signal being generated from a reference signal received at a first number of antenna elements from a terminal device, signal samples of the compressed reference signal being organized into a second number of sample sets along a spatial dimension, the second number being less than the first number; and
determining a channel estimate for the terminal device and a network device by reconstructing on the compressed reference signal, the network device comprising the baseband unit and the radio unit, the channel estimate indicating the first number of receiving branches at the network device.

8. The method of claim 7, wherein the reconstructing on the compressed reference signal is based on a compression precoder matrix, the compression precoder matrix being used to generate the compressed reference signal at the radio unit.

9. The method of claim 7, wherein determining the channel estimate comprises:
determining a compressed channel estimate based on the compressed reference signal, the compressed channel estimate indicating the second number of receiving branches; and
performing channel reconstruction from the compressed channel estimate, to obtain the channel estimate.

10. The method of claim 9, wherein performing the channel reconstruction comprises:
applying an orthogonal match pursuit (OMP) on the compressed channel estimate, to obtain the channel estimate.

11. The method of claim 10, wherein the compressed reference signal is in a time-domain compressed reference signal, and determining the compressed channel estimate comprises:
performing time-to-frequency domain transformation on the time-domain compressed reference signal, to obtain a frequency-domain compressed reference signal; and
determining the compressed channel estimate based on the frequency-domain compressed reference signal.

12. The method of claim 7, wherein the channel estimate comprises channel estimate information corresponding to a plurality of subcarriers, the method further comprising:
determining a frequency-dependent precoder for a given subcarrier of the plurality of subcarriers based on channel estimate information corresponding to the given subcarrier.

13. The method of claim 7, further comprising:
determining, based on the channel estimate, beamforming information for at least one of an uplink reception from the terminal device to the network device or a downlink transmission from the network device to the terminal device.

14. A radio unit comprising:
a processor; and
a memory, said memory containing instructions executable by said processor, whereby said radio unit is operative to:
obtain a reference signal received at a first number of antenna elements from a terminal device, signal samples of the received reference signal being organized into the first number of sample sets along a spatial dimension;
compress the received reference signal along the spatial dimension, to obtain a compressed reference signal, signal samples of the compressed reference signal being organized into a second number of sample sets along the spatial dimension, the second number being less than the first number; and
transmit the compressed reference signal to a baseband unit via a fronthaul interface.

15. (canceled)

16. A baseband unit comprising:
a processor; and
a memory, said memory containing instructions executable by said processor, whereby said baseband unit is operative to:
receive a compressed reference signal from a radio unit via a fronthaul interface, the compressed reference signal being generated from a reference signal received at a first number of antenna elements from a terminal device, signal samples of the compressed reference signal being organized into a second number of sample sets along a spatial dimension, the second number being less than the first number; and
determine a channel estimate for the terminal device and a network device by reconstructing on the compressed reference signal, the network device comprising the baseband unit and the radio unit, the channel estimate indicating the first number of receiving branches at the network device.

17-19. (canceled)
